(19) United States
(12) Patent Application Publication
(10) Pub. No.: US 2015/0251337 A1
(43) Pub. Date: Sep. 10, 2015

(54) COMPOSITE MATERIAL WITH VINE SHOOT, METHOD TO MANUFACTURE SUCH COMPOSITE MATERIAL AND AGRICULTURAL ACCESSORY MADE OF SUCH COMPOSITE MATERIAL

(71) Applicant: Stephane BIDAULT, Beaune (FR)

(72) Inventor: Stephane BIDAULT, Beaune (FR)

(21) Appl. No.: 14/614,902

(22) Filed: Feb. 5, 2015

(30) Foreign Application Priority Data
Feb. 6, 2014 (FR) 14/50918
Feb. 6, 2014 (FR) 14/50919

(51) Int. Cl. B29B 13/10; F16B 2/22; C08L 23/12; C08L 67/04; A01G 17/04; B29B 7/00

(52) U.S. Cl. CPC B29B 13/10; A01G 17/04; B29B 7/002; C08L 23/12; C08L 67/04; F16B 2/22; B29K 2023/12

(57) ABSTRACT

The invention relates to a composite material comprising at least a plastic matrix in which a powder of vine shoots is incorporated.

The invention also relates to a method of obtaining a composite material.

The invention also relates to an agricultural accessory (1, 10) intended for tying in vine stock.

The invention relates to a composite material and the method of manufacturing the said composite material

Usually, the vine shoots are trimmed during the winter season. This trimming generates between 2250 and 3500 kg of shoots per hectar of vine, which is quite significant as France counts 790 000 hectares of vine. Once trimmed and stored, these vine shoots are burned instead of being used, thus generating CO₂ dispersions into the atmosphere.

In order to reduce and/or prevent th s ecological waste, the object of the invention resides in the manufacturing of a composite material comprising at least one plastic matrix in which is incorporated a powder of vine shoots.

According to the invention, the vine shoots are hence used as raw material integrated in a composite material, thus preventing the automatic burning of these vine shoots.

Thus, the manufacturing costs of some products such as vine stakes or vine props etc., may be reduced in using a local raw material such as the one according to the invention.

Furthermore, the composite material according to the invention is a rot-proof material thanks to vine shoots, which is very advantageous if this material is used for producing outdoor tools such as vine stakes or vine props and the like. The vine shoots are very advantageous as they are lighter than most types of wood, thus allowing to obtain in fine a light composite material.

According to a feature of the invention, the proportion of powder of vine shoots is at least 20% in weight compared to the total weight of the composite material. From 20%, the cost of the petroleum matrix is considerably reduced. Preferably, the proportion of powder of vine shoots is between 20% and 70% in weight compared to the total weight of the composite material.

According to another feature of the invention, the plastic material of the matrix is a polymer selected from among a polypropylene or a polylactic acid and the combinations thereof. The use of the aforementionned plastic materials is advantageous because these materials are by definition recylable and biodegradable, in particular for polylactic acid.

An objet of the invention is also a method of manufacturing a composite material according to the invention, the method comprising at least one step of grinding vine shoots in order to obtain in fine a powder of vine shoots, at least one step of drying the vine shoots, and at least one step of incorporating said powder of vine shoots in a matrix made of plastic material.

According to a feature of the invention, the method comprises the following steps:
a first step of grinding vine shoots in order to obtain pellets of vine shoots,
a step of drying pellets of vine shoots until said pellets of vine shoots comprise a determined humidity rate,
a second step of grinding dried pellets of vine shoots until a powder of vine shoots is obtained,
a step of blending a powder of vine shoots in a matrix made of plastic material.

For example, the blending step may consist in mixing the powder of vine shoots with the plastic matrix in hot condition.

According to another feature of the invention, the first step of grinding comprises a first sub-step in which the vine shoots are grinded to chips of a size between 150 mm and 50 mm and a second sub-step in which the chips of vine shoots are reduced to pellets of a size lower than 20 mm, and preferably around 15 mm.

According to another feature of the invention, the second grinding step comprises a sub-step of screening. This screening step allows obtaining a greater proportion of particles of the same size.

According to another feature of the invention, one goes from the drying step to the second grinding step only when the pellets of vine shoots comprise a rate of humidity lower than or equal to 10% compared to the mass of a pellets.

The humidity rate is calculated as following: subtract the anhydrous mass from the humid mass, divide the result of this subtraction by the anhydrous mass and multiply by 100:

$$\frac{( humid mass - anhydrous mass )}{anhydrous mass} \times 100 = humidity rate$$

According to another feature of the invention, the powder of vine shoots comprises at least 60% of the particles forming the powder with a particle size between 300 micron and 800 micron and preferably between 500 micron and 550 micron.

The invention has also for object an agricultural accessory for the tying in of vine stock, the said agricultural accessory being made of a composite material of the invention. Thus, an agricultural accessory made of the composite material according to the invention withstands to exterior conditions and lasts longer than accessories made of wood or metal used conventionally and which rot or rust quickly.

According to a feature of the invention, the agricultural accessory is a vine stake configured to hold threads used to tie in vine shoots.

According to the invention, a vine stake is a stake used for vine tying are called head stakes when they are positioned at a row end and called intermediate stakes when they are positioned in the row, the row referring to a row of vine stocks. Each stake is driven into the ground by hitting thanks to a sledge hammer or a battering ram and is positioned in a regular manner in a row.

According to a feature of the invention, the vine stake comprises a first end intended to be driven into the ground and a second opposite free end, characterized in that the stake comprises a central portion positioned between the first end and the second end, said central portion comprising at least one housing arranged on a face of said central portion, said housing forming a notch being shaped to receive and hold at least one bearing thread or one lifting thread of vine shoots and to allow winding said thread around the stake.

Thus, thanks to the central portion of the stake, known fitted attachment means are no longer needed. The regular replacement of the attachment means is thus prevented and the thread is easily tensioned without requiring effort.

According to a feature of the invention, the central portion comprises a first lateral face and a second lateral face, the first lateral face and the second lateral face being opposite relative to a longitudinal axis of the stake, a first housing forming a notch and a second housing forming a notch being arranged respectively on the first lateral face and on the second lateral face.

According to another feature of the invention, the first housing forming a notch on the first lateral face is positioned facing the second housing forming a notch on the second lateral face, thus, when a thread is wound around the stake, the thread is held by the first and the second housings thereby facilitating winding and holding on the stake.

According to another feature of the invention, the first lateral face of the central portion comprises at least two housings positioned at a distance from one another.

According to another feature of the invention, the second lateral face of the central portion comprises at least two housings positioned at a distance from one another. Thus, it is possible to attach several threads at different heights.

Preferably, the plurality of housings arranged on the first lateral face and/or the second lateral face are advantageously spaced from each other in a regular manner.

According to another feature of the invention, the first end of the stake intended to be driven into the ground, is tip-shaped. Preferably, the first end comprises a cross-shaped section. The shape of the first end is designed to facilitate penetration and improve anchoring of the stake into the ground.

According to another feature of the invention, the stake is substantially parallelepiped-shaped, which allows storing more stakes by storage pallet. Thanks to this stake shape, it is possible to store up to about 400 stakes by pallet against 100 in the current state of the art.

Alternately, and according to another feature of the invention, said agricultural accessory is a vine clip for tying vine shoots, comprising at least one housing shaped to hold at least two lifting threads tight.

According to the invention, a vine clip is an element positioned on the lifting threads used to hold the vine stock, the said element being shaped to hold lifting threads tight in order to avoid the overcrowding of the vegetation and the exit of vine shoots.

According to another feature of the invention, said agricultural accessory comprises a first housing and a second housing, the first housing being oriented angularly relative to the second housing such as a first housing end is combined with an end of the second housing, forming a throttling section shaped to keep the lifting threads.

According to another feature of the invention, said agricultural accessory is globally cylindrical.

According to another feature of the invention, each housing is globally oblong-shaped with an opened end.

Preferably, the opened end of the first housing is combined with the opened end of the second housing.

The invention will be better understood, thanks to the following description, which relates to an embodiment according to the present invention, given by way of non-limiting example and explained with reference to the enclosed schematic drawing, in which:

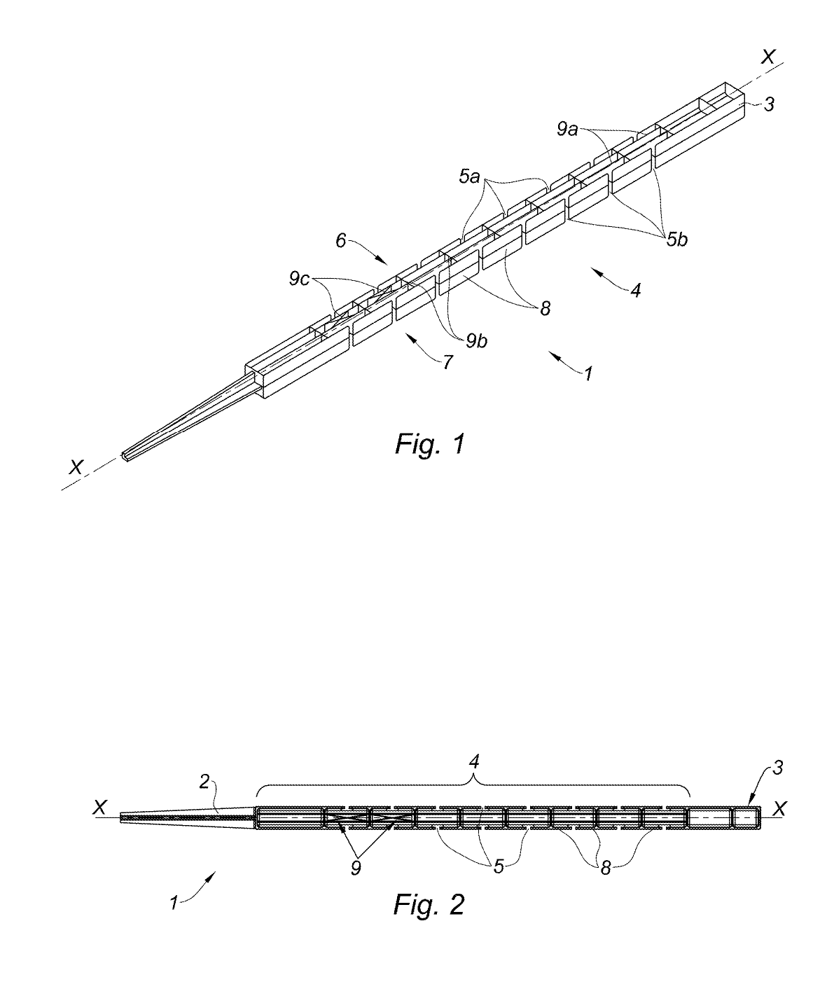

FIG. 1 represents a perspective view of a vine stake according to the invention.

FIG. 2 represents a front face of the stake represented in FIG. 1,

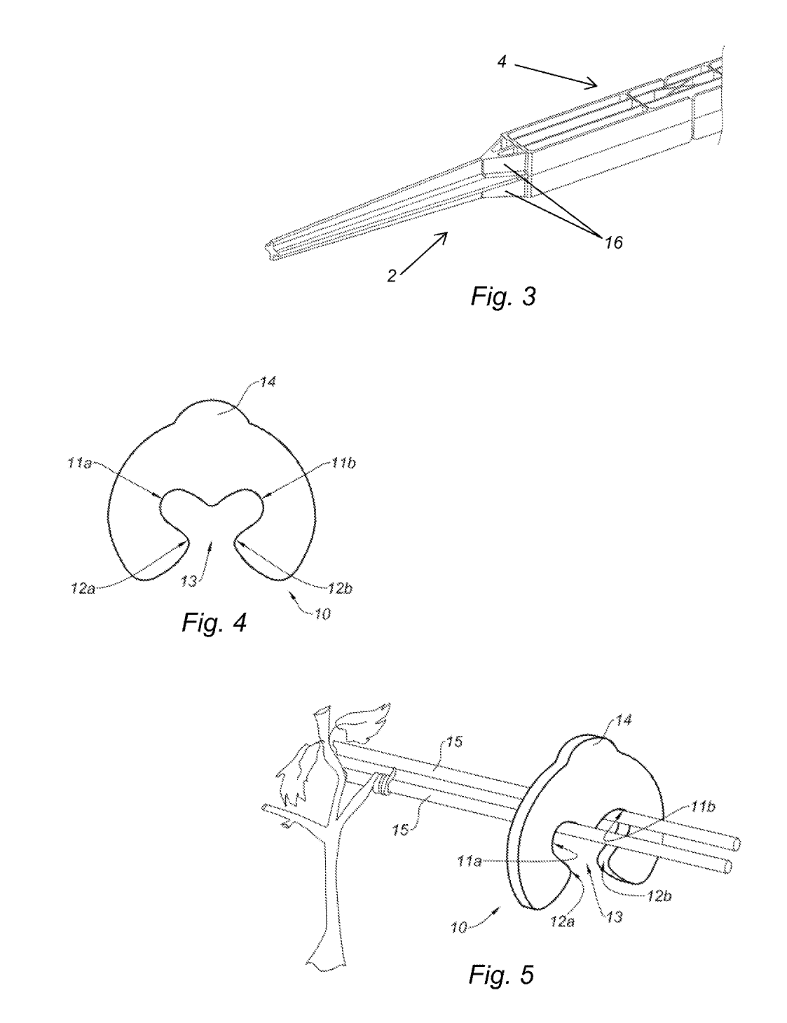

FIG. 3 represents a perspective view of a vine stake end according to a variant of the vine stake end represented in FIG. 1,

FIG. 4 represents a front face of a vine clip according to the invention,

FIG. 5 represents a perspective view of the vine clip represented in FIG. 3, in used condition.

The manufacturing method of the composite material is described hereinafter.

In order to manufacture a composite material according to the invention, the trimmed vine shoots first must be gathered, the gathering being achieved either manually, or mechanically. When the gathering is achieved mechanically, a machine with rotating blades which collects the vine shoots from the ground is used.

During the gathering, the rotating blades grind the vine shoots into chips a first time. The chips are then discharged into a storage skip of the machine.

Once all the vine shoots gathered and grinded into chips, the storage skip is poured into a chipper unit which reduces the chips of vine shoots into pellets. The size of the pellets is around 15 mm, thus being advantageous because the pellets of this size dry more quickly than pellets of a larger size.

When all the chips are grinded into pellets, the pellets are put to dry. The drying time is 3 to 6 months according to the humidity rate of the pellets. Preferably, the pellets are considered dried when the humidity rate of the said pellets is lower than or equal to 9% compared to the mass of a pellet.

According to a variant of the invention, the drying step may be realized prior to the grinding of the chips into pellets.

Once dried, the pellets are poured into a refiner comprising a grid comprising orifices of 800 micron in order to achieve the grinding of the pellets. The result of the grinding is screened in order to obtain a powder of vine shoots with a particle size between 800 micron and 300 micron.

The powder of vine shoots obtained is then transported and blended into a matrix made of plastic material in order to manufacture the composite material of the invention. Advantageously, the powder of vine shoots blended into the matrix made of plastic material is in proportion of at least 30% compared to the total weight of the composite material. Preferably, and for environmental reasons, the plastic material of the matrix is a polymer selected from among polypropylene or polylactique acid and the combinations thereof.

As represented in FIGS. 1 and 2, the agricultural accessory can be for example a vine stake or a vine clip as illustrated in FIGS. 4 and 5.

In accordance with the invention and as represented in FIGS. 1 and 2, the vine stake 1 comprises a first tip-shaped tapered end 2 and a second end 3 opposite to the first end 2. The first end 2 is designed to be driven into the ground and comprises a cross-shaped section as can be seen in FIG. 1.

The vine stake 1 also comprises a central portion 4 including a first lateral face 6 and a second lateral face 7, the first lateral lace 6 is opposite to the second lateral face 7 relative to a longitudinal axis X-X of the vine stake 1.

As illustrated in FIGS. 1 and 2, the first lateral face 6 and the second lateral face 7 are provided with a plurality of housings 5a, 5b forming a notch designed to receive and hold lifting and bearing-type supporting threads. The plurality of housings 5a, 5b is distributed in a regular manner over the first lateral face 6 and over the second lateral face 7. Each housing 5a arranged on the first lateral face 6 is positioned facing a housing 5b arranged on the second lateral face 7.

The first lateral face 6 and the second lateral face 7 comprise a plurality of planar portions 8, each housing 5a, 5b being arranged between two planar portions 8.

Advantageously, the vine stake 1 is substantially parallelepiped-shaped.

In the example illustrated in FIGS. 1 and 2, the vine stake 1 comprises a hollow structure comprising, in its central portion, reinforcement ribs 9a, 9b, 9c positioned between the first lateral face 6 and the second lateral face 7.

The ribs 9a extend along a direction substantially parallel to the longitudinal axis X-X and link the first end 2 to the second end 3. The ribs 9a extend substantially along the entire central portion 4.

The ribs 9b extend along a direction substantially perpendicular to the longitudinal axis X-X and link a planar portion 8 of the first lateral face 6 with a planar portion 8 of the second lateral face 7.

The ribs 9c are in the form of reinforcement cross-braces preferably positioned at the junction of the central portion 4 and the first end 2 of the vine stake 1.

Preferably and as shown in FIG. 1, the vine stake 1 is symmetrical relative to the longitudinal axis X-X.

As a variant represented in the FIG. 3, the first end 2 of the vine stake 1 comprises at least one driving-in element 16 triangular-shaped. Said driving-in element 16 being shaped to facilitate the penetration of the first end 2 of the vine stake 1 into the ground.

Advantageously, the second end 3 comprises a planar surface shaped to receive a sledge hammer intended to drive the vine stake 1 into the ground.

During a vine support, the vine stakes 1 are driven into the ground by means of a sledge hammer which hits the second end 3 of said stake 1. To construct a supporting structure, at least two vine stakes 1 in accordance with the invention are required.

Once the vine stakes 1 have been planted at a distance from each other, the lifting and bearing threads are stretched between these stakes 1. The threads are received in the housings 5a, 5b of each stake 1 and held in these housings 5a, 5b by winding around the stake 1.

The vine clip 10 according to the invention will be now described in reference to the FIGS. 4 and 5.

The vine clip 10 is globally cylindrical-shaped. The vine clip 10 comprises two housings 11a, 11b each shaped to hold at least one lifting threads 15 tight.

Each housing 11a, 11b is oblong-shaped and comprises one end 12a, 12b opened.

The first housing 11a is oriented angularly relative to the second housing 11b such as the opened end 12a of the first housing 11a is combined with the opened end 12b of the second housing 11b, forming a throttling section 13 shaped to keep the lifting threads 15.

The vine clip 10 comprises a protruding portion 14 positioned opposite to the throttling section 13. The protruding portion 14 facilitates the gripping ability of the vine clip 10.

Obviously, the invention is not limited to the embodiment described and represented in the appended Figure. Modifications remain possible, in particular from the aspect of the constitution of the various elements or by substituting technical equivalents, without however departing from the scope of the invention.

1. A composite material comprising at least a plastic matrix in which a powder of vine shoots is incorporated.

2. The composite material according to claim 1, wherein the proportion of powder of vine shoots is at least 20% in weight compared to the total weight of the composite material.

3. The composite material according to any one of claim 1 or 2, wherein the plastic material of the matrix is a polymer selected from among polypropylene or polylactic acid and the combinations thereof.

4. A method of manufacturing a composite material according to any one of claims 1 to 3, characterized in that the method comprises at least one step of grinding vine shoots in order to obtain in fine a powder of vine shoots, at least one step of drying the vine shoots, and at least one step of incorporating said powder of vine shoots in a matrix made of plastic material.

5. The method according to claim 4, comprising the following steps:
a first step of grinding vine shoots in order to obtain pellets of vine shoots,
a step of drying vine shoot pellets until said pellets of vine shoots comprise a determined humidity rate,
a second step of grinding dried pellets of vine shoots until a powder of vine shoots is obtained,
a step of blending the powder of vine shoots in a matrix made of plastic material.

6. The method according to claim 5, wherein the first grinding step comprises a first sub-step in which the vine shoots are grinded into chips of a size between 150 mm and 50 mm and a second sub-step in which the chips of vine shoots are grinded into pellets of a size lower than 20 mm.

7. The method according to any one of claim 5 or 6, wherein one goes from the drying step to the second grinding step only when the pellets of vine shoots comprise a humidity rate lower than or equal to 10% compared to the mass of a pellets.

8. The method according to any one of claims 5 to 7, wherein the second grinding step comprises a sub-step of screening.

9. The method according to any one of claims 4 to 8, wherein the powder of vine shoots comprises at least 60% of the particles forming the powder with a particle size between 300 micron and 800 micron.

10. Agricultural accessory (1, 10) intended for tying in vine stock, characterized in that the said agricultural accessory is manufactured with the composite material according to any one of claims 1 to 3.

11. Agricultural accessory according to claim 10, wherein the said agricultural accessory (1) is a vine stake (1) configured to hold threads used to tying-in vine shoots.

12. Agricultural accessory according to claim 11, wherein the said agricultural accessory (1) comprises comprising a first end (2) intended to be driven into the ground and a second opposite free end (3), characterized in that the agricultural accessory (1) comprises a central portion (4) positioned between the first end (2) and the second end (3), said central portion (4) comprising at least one housing (5a, 5b) arranged on a face (6,7) of said central portion (4), said housing (5a, 5b) forming a notch being shaped to receive and hold at least one bearing thread or one lifting thread of vine shoots and to allow winding said thread around the agricultural accessory (1).

13. Agricultural accessory according to claim 12, wherein the central portion (4) comprises a first lateral face (6) and a second lateral face (7), the first lateral face (6) and the second lateral face (7) being opposite relative to a longitudinal axis (X-X) of the stake (1), a first housing (5a) forming a notch and a second housing (5b) forming a notch being arranged respectively on the first lateral face (6) and on the second lateral face (7).

14. Agricultural accessory according to claim 10, wherein the said agricultural accessory (10) is a vine clip (10) comprising at least one housing (11a, 11b) shaped to hold at least two lifting threads (15) tight.

15. Agricultural accessory according to claim 14, wherein the said agricultural accessory (10) comprises a first housing (11a) and a second housing (11b), the first housing (11a) being oriented angularly relative to the second housing (11b) such as a first housing end (12a) is combined with an end (12b) of the second housing (11b), forming a throttling section (13) shaped to keep the lifting threads (15).
